(19) United States
(12) Patent Application Publication
(10) Pub. No.: US 2024/0257334 A1
(43) Pub. Date: Aug. 1, 2024

(54) AUTOMATED PART INSPECTION SYSTEM

(71) Applicants: TE Connectivity Solutions GmbH, Schaffhausen (CH); Tyco Electronics (Shanghai) Co., Ltd., Shanghai (CN)

(72) Inventors: Sonny O. Osunkwo, Harrisburg, PA (US); Lei Zhou, Shanghai (CN); Roberto Francisco-Yi Lu, Bellevue, WA (US); Swapnilsinh Solanki, Harrisburg, PA (US); Peter Vercampt, Winston Salem, NC (US)

(21) Appl. No.: 18/166,526

(22) Filed: Feb. 9, 2023

(30) Foreign Application Priority Data
Feb. 1, 2023 (CN) 202310085742.8

(51) Int. Cl. G06T 7/00

(52) U.S. Cl. CPC G06T 7/001; G06T 2200/24; G06T 2207/20081; G06T 2207/20084; G06T 2207/20092; G06T 2207/30108

(57) ABSTRACT

A part inspection system includes a vision device imaging a part being inspected and generating a digital image of the part. The part inspection system includes a part inspection module for inspecting part quality of the part based on the digital image of the part. The part inspection module includes a machine vision inspection module and an AI inspection module. The machine vision inspection module receives the digital image of the part, analyzes the digital image to determine a first part quality of the part in the digital image, and generates a first part quality output based on the analysis of the digital image. The AI inspection module receives the same digital image of the part. The AI inspection module analyzes the digital image to determine a second part quality of the part in the same digital image and generates a second part quality output based on the analysis of the same digital image. The part inspection module compares the first part quality output and the second part quality output.

### CROSS REFERENCE TO RELATED APPLICATIONS

This application claims benefit to Chinese Application No. 202310085742.8, filed 1 Feb. 2023, the subject matter of which is herein incorporated by reference in its entirety.

### BACKGROUND OF THE INVENTION

The subject matter herein relates generally to part inspection systems and methods.

With the development of image processing technologies, image processing technologies have been applied to defect detection in manufactured products. In practical applications, after one or more manufacturing steps, parts may be imaged and the images analyzed to detect for defects, such as prior to assembly of the part or shipment of the part. Some defects are difficult for known image processing systems to identify. Additionally, processing time for the processing system may be extensive when detecting some types of defects or some types of products, leading to slow throughput. Moreover, training time for the processing system leads to increased cost of the system due to the valuable time spent re-training and fine tuning the system. Furthermore, accuracy of the inspection system is affected by many factors, including the calibration or training of the system as well as the quality of the image taken and analyzed.

A need remains for a robust part inspection system and method.

### BRIEF DESCRIPTION OF THE INVENTION

In one embodiment, a part inspection system is provided and includes a vision device configured to image a part being inspected and generate a digital image of the part. The part inspection system includes a part inspection module for inspecting part quality of the part based on the digital image of the part. The part inspection module includes a machine vision inspection module and an AI inspection module. The machine vision inspection module receives the digital image of the part. The machine vision inspection module analyzes the digital image to determine a first part quality of the part in the digital image. The machine vision inspection module generates a first part quality output based on the analysis of the digital image. The AI inspection module receives the same digital image of the part. The AI inspection module analyzes the digital image to determine a second part quality of the part in the same digital image. The AI inspection module generates a second part quality output based on the analysis of the same digital image. The part inspection module compares the first part quality output and the second part quality output.

In another embodiment, a part inspection system is provided and includes a vision device configured to image a part being inspected and generate a digital image of the part. The part inspection system includes a part inspection module for inspecting part quality of the part based on the digital image of the part. The part inspection module includes a machine vision inspection module and an AI inspection module. The machine vision inspection module receives the digital image of the part. The machine vision inspection module analyzes the digital image to determine a first part quality of the part in the digital image. The machine vision inspection module generates a first part quality output based on the analysis of the digital image. The first part quality output being one of PASS or FAIL. The AI inspection module receives the same digital image of the part. The AI inspection module analyzes the digital image to determine a second part quality of the part in the same digital image. The AI inspection module generates a second part quality output based on the analysis of the same digital image. The second part quality output being one of PASS or FAIL. The part inspection module compares the first part quality output and the second part quality output to determine if the first and second part quality outputs are the same or different. The part inspection module performs additional part inspection if the first and second part quality outputs are different.

In a further embodiment, a part inspection method is provided and includes imaging a part using a vision device to generate a digital image. The method analyzes the digital image through a machine vision inspection module of a part inspection system by comparing the digital image to a quality threshold to determine if the digital image passes or fails the quality threshold. The machine vision inspection module generates a first part quality output. The method analyzes the digital image through an AI inspection module of the part inspection system by comparing the digital image to a quality threshold to determine if the digital image passes or fails the quality threshold. The AI inspection module generates a second part quality output. The method compares the first part quality output and the second part quality output to determine if the first and second part quality outputs are the same or different. The part inspection system performs additional part inspection if the first and second part quality outputs are different.

### BRIEF DESCRIPTION OF THE DRAWINGS

FIG. 1 illustrates a part inspection system in accordance with an exemplary embodiment.

FIG. 2 illustrates portions of images of parts taken by the part inspection system in accordance with an exemplary embodiment.

FIG. 3 illustrates portions of images of parts taken by the part inspection system in accordance with an exemplary embodiment.

FIG. 4 illustrates portions of images of parts taken by the part inspection system in accordance with an exemplary embodiment.

FIG. 5 is a flow chart of a method of inspecting parts in accordance with an exemplary embodiment.

FIG. 6 is a flow chart of a method of inspecting parts in accordance with an exemplary embodiment.

### DETAILED DESCRIPTION OF THE INVENTION

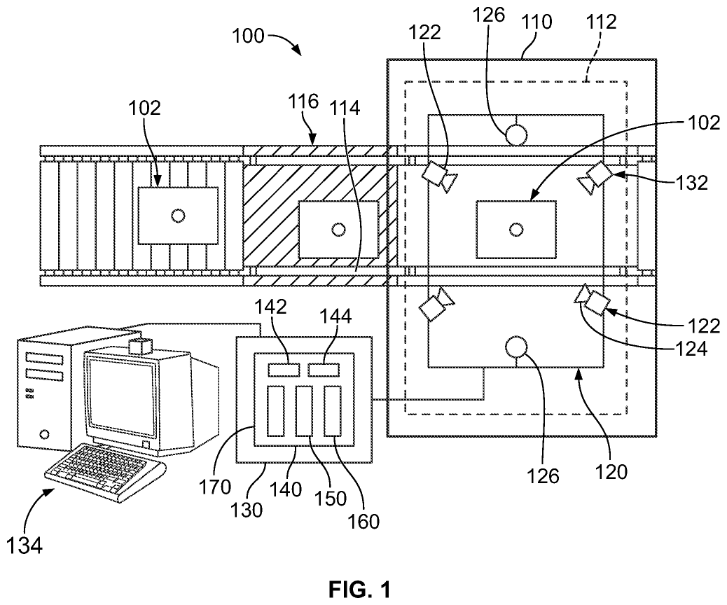

FIG. 1 illustrates a part inspection system 100 in accordance with an exemplary embodiment. The part inspection system 100 is used to inspect parts 102 for defects. The part inspection system 100 is a vision inspection system using one or more processors to analyze digital images of the part 102 for defects. In an exemplary embodiment, the part inspection system 100 includes redundant inspection modules that inspect the parts 102. The inspection modules use different inspection techniques and algorithms to inspect the parts 102 for defects. For example, a primary inspection module inspects the parts 102 using a first inspection program and a secondary inspection module operates as a backup inspection module using a second inspection program to inspect the parts 102. As such, the part inspection system 100 provides robust inspection of the parts 102. In various embodiments, the first inspection module is a machine vision inspection module using machine vision inspection techniques to inspect the parts 102. For example, the machine vision inspection module uses programmed logic to analyze the image. In various embodiments, the second inspection module is an artificial intelligence (AI) inspection module using AI inspection techniques to inspect the parts 102. For example, the AI inspection module uses AI trained decision logic to analyze the image. In an exemplary embodiment, the same inspection hardware is used by both inspection modules. As such, the hardware cost is the same with the enhanced inspection of the dual inspection modules.

In various embodiments, the part 102 may be an electrical connector, an electrical contact, a circuit board, or other type of electrical component. In an exemplary embodiment, the part inspection system 100 is used to inspect the parts 102 for proper assembly of components, for missing components, for damage to the components, or for other defects. The part inspection system 100 analyzes digital images of the part 102 to detect defects. The part inspection system 100 may be used to analyze the digital images for one particular type of defect or for multiple, different types of defects.

The part inspection system 100 includes an inspection station 110. The inspection station 110 may be located downstream of a processing station (for example, an assembly machine, a loading machine, a wire preparation machine, a contact forming machine, a stamping machine, a drill press, a cutting machine, and the like) to inspect the part 102 after processing. In other various embodiments, the inspection station 110 may be located at the processing station. The inspection station 110 includes an inspection zone 112.

In an exemplary embodiment, the inspection station 110 includes a locating feature 114 for locating the part 102 relative to the inspection zone 112. The locating feature 114 may be a table or other support platform used to hold and support the part 102 in the inspection station 110. The locating feature 114 may include one or more walls or other features forming datum surfaces for locating the part 102. The locating feature 114 may include a clamp or bracket holding the part 102. During use, the part 102 is presented at the inspection zone 112 for inspection. For example, the part 102 may abut against the locating feature 114 to locate the part 102 at the inspection zone 112. The part 102 may be moved within the inspection zone 112 by the locating feature 114.

In an exemplary embodiment, the inspection station 110 may include a manipulator 116 for moving the part 102 relative to the inspection station 110. For example, the manipulator 116 may include a conveyor or vibration tray for moving the part 102 through the inspection station 110. In other various embodiments, the manipulator 116 may include a feeder device, such as a feed finger used to advance the part 102, which is held on a carrier, such as a carrier strip. In other various embodiments, the manipulator 116 may include a multi-axis robot configured to move the part 102 in three-dimensional space within the inspection station 110. In alternative embodiments, the manipulator 116 may be an automated guided vehicle (AGV) configured to move the part 102 between various stations. In other alternative embodiments, the part 102 may be manually manipulated and positioned at the inspection zone 112 by hand.

The part inspection system 100 includes a vision device 120 for imaging the part 102 at the inspection zone 112. The vision device 120 may be mounted to a frame or other structure of the inspection station 110. The vision device 120 includes a camera 122 used to image the part 102. The camera 122 may be movable within the inspection zone 112 relative to the part 102 (or the part 102 may be movable relative to the camera 122) to change a working distance between the camera 122 and the part 102, which may affect the clarity of the image. Other types of vision devices 120 may be used in alternative embodiments, such as an infrared camera, or other type of camera that images at wavelengths other than the visible light spectrum.

In an exemplary embodiment, the part inspection system 100 includes a lens 124 at the camera 122 for controlling imaging. The lens 124 may be used to focus the field of view. The lens 124 may be adjusted to change a zoom level to change the field of view. The lens 124 is operated to adjust the clarity of the image, such as to achieve high quality images.

In an exemplary embodiment, the part inspection system 100 includes a lighting device 126 to control lighting conditions in the field of view of the vision device 120 at the inspection zone 112. The lighting device 126 may be adjusted to control properties of the lighting, such as brightness, light intensity, light color, and the like. The lighting affects the quality of the image generated by the vision device 120. The background behind the part 102 may affect the quality of the image and may be affected by the lighting of the lighting device. Additionally, ambient lighting may affect the quality of the image and may be adjusted to enhance the quality of the image.

In an exemplary embodiment, the vision device 120 is operably coupled to a controller 130. The controller 130 is operably coupled to the vision device 120 to control operation of the vision device 120. The controller 130 may receive input from the vision device 120. For example, the controller 130 may receive the digital images from the camera 122.

The controller 130 is operably coupled to a vision inspection module 140. The vision inspection module 140 is used to analyze the digital images from the camera 122 for quality analysis of the parts 102 (for example, proper assembly, damage, missing components, and the like). The vision inspection module 140 may be embedded in the controller 130. Alternatively, the vision inspection module 140 may be separate from the controller 130 and communicatively coupled to the controller 130, such as through a communication bus or via wireless communication. In an exemplary embodiment, the vision inspection module 140 includes a first inspection module 150 and a second inspection module 160. The controller 130 receives one or more outputs from the first and second inspection modules 150, 160. The first and second inspection modules 150, 160 use different inspection techniques and algorithms to inspect the parts 102 for defects. In various embodiments, the first inspection module 150 is a machine vision inspection module using machine vision inspection techniques to inspect the parts 102. The first inspection module 150 may be referred to hereinafter as a machine vision inspection module 150. In various embodiments, the second inspection module 160 is an AI inspection module using AI inspection techniques to inspect the parts 102. The second inspection module 160 may be referred to hereinafter as an AI inspection module 160.

In an exemplary embodiment, the controller 130 is operatively coupled to one or more secondary components 132 and sends control signals to the secondary component(s) 132 based on the received output. For example, the control signals may be based on the part quality output from the vision inspection module 140. The secondary component 132 may be a user interface in various embodiments. For example, the secondary component 132 may include a display that is controlled by the controller 130. In various embodiments, the secondary component 132 is an actuator configured to move the part 102. The control signal from the controller 130 causes the actuator to move the part 102 differently dependent on the received output. In various embodiments, the controller 130 may be operably coupled to the manipulator 116 to control operation of the manipulator 116. For example, the controller 130 may cause the manipulator 116 to move the part 102 into or out of the inspection station 110. The controller 130 may cause the manipulator 116 to move the part 102 within the inspection station 110, such as to move the part 102 relative to the camera 122. The secondary component 132 may be associated with the lighting device 126. The control signal from the controller 130 may cause the lighting device 126 to change lighting of the part dependent on the received output.

In an exemplary embodiment, the controller 130 is operably coupled to the vision device 120 and controls operation of the vision device 120. For example, the controller 130 may cause the vision device 120 to take an image or retake an image. In various embodiments, the controller 130 may move the camera 122 to a different location, such as to image the part 102 from a different angle.

The controller 130 may be operably coupled to the lens 124 to change the imaging properties of the vision device 120, such as the field of view, the focus point, the zoom level, the resolution of the image, and the like. For example, the lens 124 may be automatically adjusted by the controller 130, such as when the image quality is too low (for example, below a quality threshold).

The controller 130 may be operably coupled to the lighting device 126 to change the imaging properties of the vision device 120. For example, the brightness, the intensity, the color or other lighting properties of the lighting device 126 may be altered or changed to enhance the image quality. For example, the lighting device 126 may be automatically adjusted by the controller 130, such as when the image quality is too low (for example, below a quality threshold).

In various embodiments, the part inspection module 140 may be embedded in the controller 130 or the part inspection module 140 and the controller 130 may be integrated into a single computing device. The part inspection module 140 receives the digital image of the part 102 from the vision device 120. The part inspection module 140 analyzes the digital image and generates part quality outputs based on the analysis. For example, both the machine vision inspection module 150 and the AI inspection module 160 may provide separate quality outputs based on the independent analysis of the digital image. The output(s) is used by the controller 130, such as for other control functions of the part inspection system 100. In an exemplary embodiment, the part inspection module 140 includes one or more memories 142 for storing executable instructions and one or more processors 144 configured to execute the executable instructions stored in the memory 142 to inspect the part 102. For example, each of the machine vision inspection module 150 and the AI inspection module 160 may include a corresponding memory 142 and corresponding processor 144. The memories 142 may include a neural network architecture in various embodiments, such as a VGG neural network. The processor 144 is configured to analyze the digital image through the layers of the neural network architecture to output a part quality output, such as to identify the part as being one of defective or non-defective based on the image analysis of the digital image through the neural network architecture.

In an exemplary embodiment, the machine vision inspection module 150 analyzes the digital image to determine one or more quality characteristics of the part 102 in the digital image. The machine vision inspection module 150 analyzes the digital image to classify the part as a defective part or a non-defective part. The machine vision inspection module 150 determines if the part achieves a quality threshold. The machine vision inspection module 150 generates a part quality output based on the analysis of the digital image. The part quality output is based on the quality threshold. In various embodiments, the part quality output may be a binary output, such as corresponding to the part quality being “good” if above the quality threshold or the part quality being “bad” if below the quality threshold. Optionally, the part quality output may be “PASS” or “OK” if the part analysis passes the quality threshold and the part quality output may be “FAIL” or “NG” if the part fails the quality threshold. In other embodiments, the part quality output may be a scalar output, such as an output on a scale of between 1 and 10 or between 1 and 100. The quality threshold may be adjustable, such as manually by a user or automatically by the AI inspection module.

In an exemplary embodiment, the AI inspection module 160 analyzes the same digital image to determine one or more quality characteristics of the part 102 in the digital image. The AI inspection module 160 analyzes the digital image, using a different algorithm or technique from the machine vision inspection module 150, to classify the part as a defective part or a non-defective part. The AI inspection module 160 generates a part quality output based on the analysis of the digital image. In various embodiments, the part quality output may be a binary output, such as corresponding to the part quality being “good” or the part quality being “bad”. Optionally, the part quality output may be “PASS” or “OK” if the part analysis passes a quality threshold and the part quality output may be “FAIL” or “NG” if the part fails the quality threshold. In other embodiments, the part quality output may be a scalar output, such as an output on a scale of between 1 and 10 or between 1 and 100. In an exemplary embodiment, the AI inspection module 160 uses a neural network architecture to analyze the image. In an exemplary embodiment, the neural network architecture is stored as executable instructions in the memory 142. The processor 144 uses the neural network architecture by executing the stored instructions. The neural network architecture is used for analyzing the part 102, such as for defect detection. For example, the neural network architecture analyzes the digital images from the vision device 120 to classify the part 102 as defective or non-defective.

In an exemplary embodiment, the neural network architecture uses machine learning to analyze the images. The neural network architecture may be trained using the images form the camera 122. Some of the images used in training the AI inspection module 160 are images of defective parts, while other images are images of non-defective parts. The images may be randomly rotated and flipped during training to enhance the machine learning AI training module. The AI inspection module 160 may be operated in a training mode, such as during initial set-up of the system, such as when a limited number of images are available for training. Over time, the efficiency of the AI inspection module 160 is improved, such as when a large number of images have been analyzed.

In an exemplary embodiment, the vision inspection module 140 includes a review module 170 for additional inspection and review. For example, the inspection results from the machine vision inspection module 150 and the AI inspection module 160 may be compared. The results are compared to determine if there are discrepancies between the inspection results. The part inspection module 140 performs additional part inspection if the part quality outputs are different. The review module 170 is used to further review or inspect the digital image if the part quality outputs are different. For example, if the machine vision inspection module 150 determines that the part quality is good (PASS or OK) and the AI inspection module 160 determines that the part quality is bad (FAIL or NG), then the part inspection module 140 performs additional part inspection. Similarly, if the machine vision inspection module 150 determines that the part quality is bad (FAIL or NG) and the AI inspection module 160 determines that the part quality is good (PASS or OK), then the part inspection module 140 performs additional part inspection. The additional part inspection is performed by the review module 170.

In an exemplary embodiment, the review module 170 includes a user interface. The image is presented to the user interface for review by a human operator to determine if the part in the image is good or bad. The determination by the human operator may be used by the vision inspection module 140 to update operation of the part inspection system 100. For example, if the AI inspection module 160 was incorrect, the determination may be used to update or train the AI inspection module 160. If the machine vision inspection module 150 was incorrect, then one or more settings of the part inspection system 100 may need to be revised. For example, the settings in the machine vision module may need to be adjusted. Additionally or alternatively, the vision device 120 may need to be improved, such as by focusing the lens, changing the lighting, and the like.

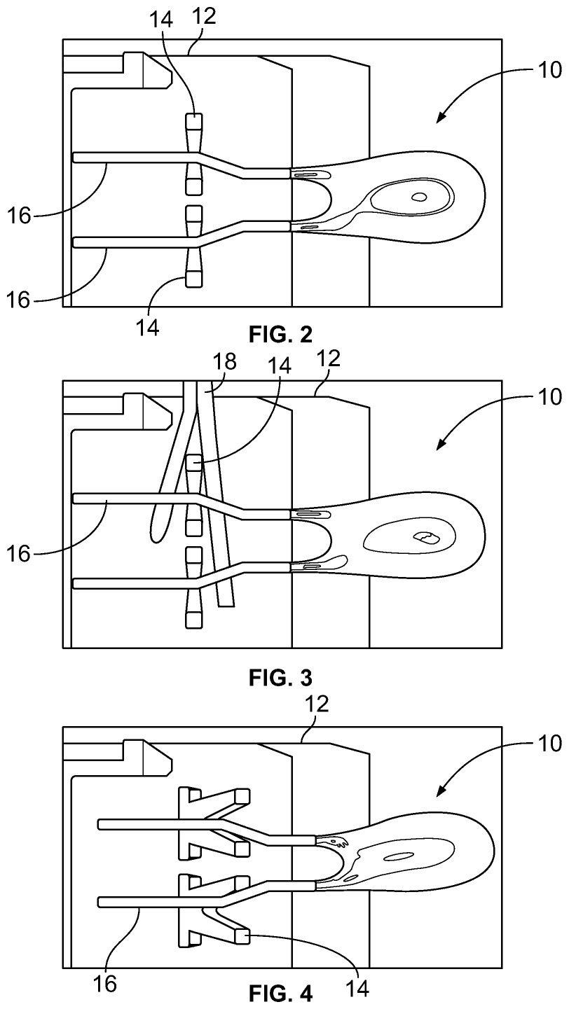

FIGS. 2-4 are portions of images of parts taken by the part inspection system 100 in accordance with an exemplary embodiment. FIG. 2 illustrates the part 102 without any defects. FIG. 3 illustrates the part 102 having a defect. FIG. 4 illustrates the part 102 having a different kind of defect. In the illustrated embodiment, the part 102 is an electrical connector 10 having a housing 12 and contacts 14 coupled to the housing 12. Wires 16 are terminated to the contacts 14. The electrical connector 10 is one example of a part that may be checked for quality control by the part inspection system 100. However, other types of parts may be checked for quality control in other embodiments.

The part inspection system 100 is able to identify different types of defects. FIG. 3 shows a foreign object 20 within the electrical connector 10. The part inspection system 100 should identify the part as defective. For example, the part inspection system 100 may output a FAIL or NG output indicating that the part should be rejected. FIG. 4 shows damaged components within the electrical connector 10. For example, the contacts 14 are bent and out of proper position. The part inspection system 100 should identify the part as defective. For example, the part inspection system 100 may output a FAIL or NG output indicating that the part should be rejected. In an exemplary embodiment, the first and second inspection modules 150, 160 both provide part quality outputs, which may both be a FAIL or NG output indicating that the parts are defective. However, if the first and second inspection modules 150, 160 have different outputs, then the part inspection module 100 may perform additional inspection, such as manual inspection of the image by an operator to verify if the part in the image is defective or not. In an exemplary embodiment, the images are used to train the AI inspection module 160.

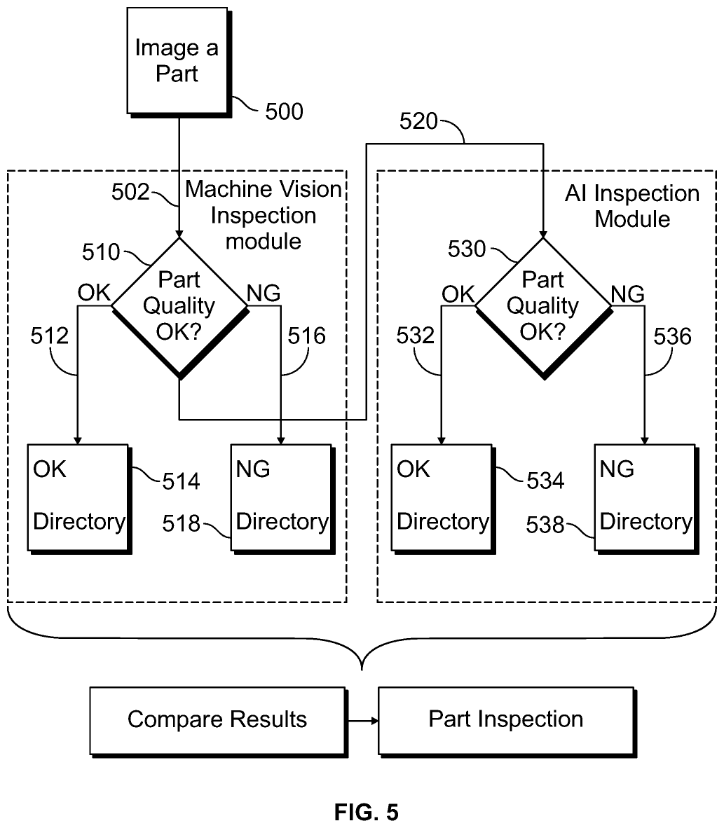

FIG. 5 is a flow chart of a method of inspecting parts using a part inspection system having first and second inspection modules that analyze the images using different algorithms and decision logic to analyze the parts in the images. The method, at step 500, includes imaging the part using a vision device (for example, camera) to generate a digital image. The method, at 502, includes sending the digital image to a first vision inspection module, such as a machine vision inspection module.

At 510, the method includes processing the image at the machine vision inspection module, to determine the part quality of the part in the image. The machine vision inspection module uses programmed logic to analyze the image. The image is analyzed for defects. At 512, the machine vision inspection module generates a first part quality output (for example, “PASS” or “OK”) if the part analysis passes the quality threshold. At 514, the machine vision inspection module sends the image to a first directory if the part quality is good. At 516, the machine vision inspection module generates a second part quality output (for example, “FAIL” or “NG”) if the part fails the quality threshold. At 518, the machine vision inspection module sends the image to a second directory if the part quality is bad.

At 520, the method includes sending the digital image to a second vision inspection module, such as an AI inspection module. At 530, the method includes processing the image at the AI inspection module, to determine the part quality of the part in the image. The AI inspection module uses AI trained decision logic to analyze the image. The image is analyzed for defects. At 532, the AI inspection module generates a third part quality output (for example, “PASS” or “OK”) if the part analysis passes the quality threshold. At 534, the AI inspection module sends the image to a third directory if the part quality is good. At 536, the AI inspection module generates a fourth part quality output (for example, “FAIL” or “NG”) if the part fails the quality threshold. At 538, the AI inspection module sends the image to a fourth directory if the part quality is bad.

At 540, the method includes comparing the results from the machine vision inspection module and the AI inspection module. For example, the machine vision directories and the AI directories are compared. The results are compared to determine if there are discrepancies between the inspection results determined by the machine vision inspection module and the AI inspection module. In an embodiment, the first directory is compared with the fourth directory. If the same image is sent to the first directory by the machine vision inspection module 150 (OK) and sent to the fourth directory by the AI inspection module 160 (NG), then a discrepancy exists. Similarly, if the same image is sent to the second directory by the machine vision inspection module 150 (NG) and sent to the third directory by the AI inspection module 160 (OK), then a discrepancy exists.

At 542, the part inspection module performs additional part inspection if the part quality outputs are different. For example, if the machine vision inspection module determines that the part quality is good (PASS or OK) and the AI inspection module determines that the part quality is bad (FAIL or NG), then the part inspection module performs additional part inspection. Similarly, if the machine vision inspection module determines that the part quality is bad (FAIL or NG) and the AI inspection module determines that the part quality is good (PASS or OK), then the part inspection module performs additional part inspection. The additional part inspection may be performed by a review module. The additional part inspection may be performed by a human operator. For example, the image may be presented to the human operator for manual review and part quality determination. In various embodiments, the image is emailed to the operator for manual review.

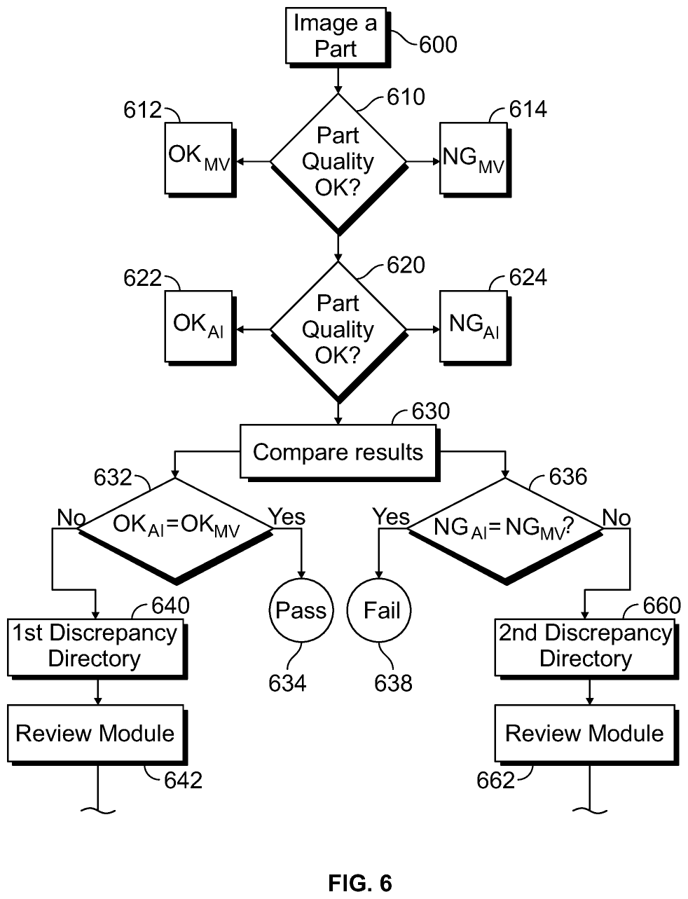

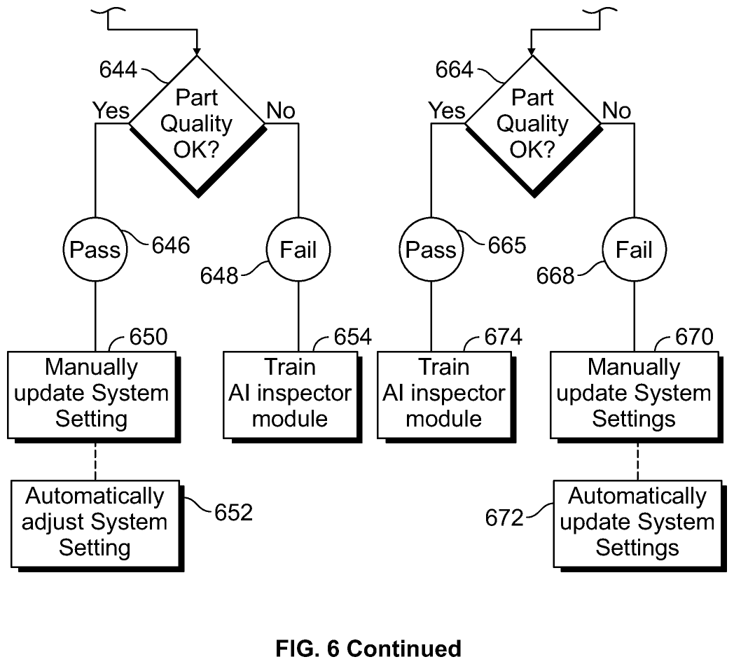

FIG. 6 is a flow chart of a method of inspecting parts using a part inspection system having first and second inspection modules that analyze the images using different algorithms and decision logic to analyze the parts in the images. The method, at step 600, includes imaging the part using a vision device (for example, camera) to generate a digital image.

At 610, the method includes processing the image at a machine vision inspection module, to determine the part quality of the part in the image. At 612, the machine vision inspection module generates a first part quality output (for example, “PASS” or “OK”) if the part analysis passes the quality threshold. At 614, the machine vision inspection module generates a second part quality output (for example, “FAIL” or “NG”) if the part fails the quality threshold.

At 620, the method includes processing the image at an AI inspection module, to determine the part quality of the part in the image. At 622, the AI inspection module generates a third part quality output (for example, “PASS” or “OK”) if the part analysis passes the quality threshold. At 624, the AI inspection module generates a fourth part quality output (for example, “FAIL” or “NG”) if the part fails the quality threshold.

At 630, the method includes comparing the results from the machine vision inspection module and the AI inspection module. The results are compared to determine if there are discrepancies between the inspection results determined by the machine vision inspection module and the AI inspection module. At 632, the method determines if the OK images from the AI inspection module have corresponding OK images from the machine vision inspection module. At 634, for the images that are both determined to be OK, the system outputs a PASS output indicating that the parts associated with such images pass inspection. At 636, the method determines if the NG images from the machine vision inspection module are the same as the NG images from the AI inspection module. At 638, for the images that are both determined to be NG, the system outputs a FAIL output indicating that the parts associated with such images fail inspection.

At 640, if the system determines that an image identified as OK by the AI inspection module is not identified as OK by the machine vision inspection module, a discrepancy occurs. The image is sent to a first discrepancy directory. At 642, if images are present in the first discrepancy directory, the system sends the image to a review module. At 644, an operator reviews the image and determines part quality after review of the image. At 646, the operator outputs a PASS output if the part is good. At 648, the operator outputs a FAIL output if the part is bad. Based on the operator review, the system may be updated. For example, at 650, if the operator output is a PASS output (the AI inspection module correctly identified the image but the machine vision inspection module incorrectly identified the image), the system sends a prompt to the operator to update the system settings. At 652, the system may optionally automatically adjust one or more system settings, such as adjusting the camera, the lens, the lighting, and the like. At 654, if the operator output is a FAIL output (the AI inspection module incorrectly identified the image but the machine vision inspection module correctly identified the image), the system uses the image to train the AI inspection module.

At 660, if the system determines that an image identified as NG by the AI inspection module is not identified as NG by the machine vision inspection module, a discrepancy occurs. The image is sent to a second discrepancy directory. At 662, if images are present in the second discrepancy directory, the system sends the image to the review module. At 664, an operator reviews the image and determines part quality after review of the image. At 665, the operator outputs a PASS output if the part is good. At 668, the operator outputs a FAIL output if the part is bad. Based on the operator review, the system may be updated. For example, at 670, if the operator output is a FAIL output (the AI inspection module correctly identified the image but the machine vision inspection module incorrectly identified the image), the system sends a prompt to the operator to update the system settings. At 672, the system may optionally automatically adjust one or more system settings, such as adjusting the camera, the lens, the lighting, and the like. At 674, if the operator output is a PASS output (the AI inspection module incorrectly identified the image but the machine vision inspection module correctly identified the image), the system uses the image to train the AI inspection module.

With additional reference back to FIG. 1, the neural network architecture is implemented by the part inspection module 140, including the one or more memories 142 and the one or more processors 144. The processor 144 is operative to perform exemplary method steps, or in the form of a non-transitory computer readable medium embodying computer executable instructions which when executed by a computer (for example, the controller 130 or a computer employing the controller 130 or operated by the controller 130) cause the computer to perform exemplary method steps. The computer system may be a cloud computing node. Examples of well-known computing systems, environments, and/or configurations that may be suitable for operation of the neural network architecture include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. One or more embodiments can make use of software running on a general purpose computer or workstation.

In an exemplary embodiment, the controller 130 receives the output from the part inspection module 140. For example, the controller 130 may receive either a 0 or a 1, indicating PASS/NON-DEFECTIVE or FAIL/DEFECTIVE, respectively. In an exemplary embodiment, the output is used by the controller 130 for other control functions of the part inspection system 100. For example, the controller 130 may cause the part to be moved after receiving the output. The controller 130 may control the manipulator 116 to move the part out of the inspection station 110. In various embodiments, the controller 130 may cause the part to move to one direction/location/bin/machine/station if defective and cause the part to move to a different direction/location/bin/machine/station is non-defective. In other various embodiments, the controller 130 is coupled to a user interface 134. The user interface 134 may include an indicator to indicate to the operator the status of the output. For example, the indicator may include a display and/or a visual indicator and/or an audible indicator to indicate to the operator the status (for example, PASS/FAIL). The operator may then manually discard the defective parts.

During operation of the neural network architecture, the part inspection module 140 runs programs to analyze the image. For example, the part inspection module 140 operates programs stored in the memory 142 on the processor 144. The processor 144 may include computer system executable instructions, such as program modules, being executed by a computer system. Generally, program modules may include routines, programs, objects, components, logic, data structures, and so on that perform particular tasks or implement particular abstract data types. The computing may be practiced in distributed cloud computing environments where tasks are performed by remote processing devices that are linked through a communications network. In a distributed cloud computing environment, program modules may be located in both local and remote computer system storage media including memory storage devices.

In an exemplary embodiment, various components may be communicatively coupled by a bus, such as the memory 142 and the processors 144. The bus represents one or more of any of several types of bus structures, including a memory bus or memory controller, a peripheral bus, an accelerated graphics port, and a processor or local bus using any of a variety of bus architectures.

The part inspection module 140 may include a variety of computer system readable media. Such media may be any available media that is accessible by the part inspection module 140, and it includes both volatile and non-volatile media, removable and non-removable media. The memory 142 can include computer system readable media in the form of volatile memory, such as random access memory (RAM) and/or cache memory. The part inspection module 140 may further include other removable/non-removable, volatile/non-volatile computer system storage media. By way of example only, a storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. The memory 142 may include at least one program product having a set (e.g., at least one) of program modules that are configured to carry out the functions of embodiments of the invention.

One or more programs may be stored in the memory 142, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the subject matter described herein.

The part inspection module 140 may also communicate with one or more external devices, such as through the controller 130. The external devices may include a keyboard, a pointing device, a display, and the like; one or more devices that enable a user to interact with system; and/or any devices (e.g., network card, modem, etc.) that enable the system to communicate with one or more other computing devices. Such communication can occur via Input/Output (I/O) interfaces. Still yet, part inspection module 140 can communicate with one or more networks such as a local area network (LAN), a general wide area network (WAN), and/or a public network (e.g., the Internet) via network adapter. Other hardware and/or software components could be used in conjunction with the system components shown herein. Examples include, but are not limited to: microcode, device drivers, redundant processing units, and external disk drive arrays, RAID systems, tape drives, and data archival storage systems, etc.

The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 144, memory 142, and input/output interface can be interconnected, for example, via the bus as part of a data processing unit. Suitable interconnections, for example via bus, can also be provided to a network interface, such as a network card, which can be provided to interface with a computer network, and to a media interface, such as a diskette or CD-ROM drive, which can be provided to interface with suitable media.

Accordingly, computer software including instructions or code for performing the methodologies of the subject matter herein may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A part inspection system comprising:
a vision device configured to image a part being inspected and generate a digital image of the part;
a part inspection module for inspecting part quality of the part based on the digital image of the part, the part inspection module including a machine vision inspection module and an AI inspection module, the machine vision inspection module receiving the digital image of the part, the machine vision inspection module analyzing the digital image to determine a first part quality of the part in the digital image, the machine vision inspection module generating a first part quality output based on the analysis of the digital image, the AI inspection module receiving the same digital image of the part, the AI inspection module analyzing the digital image to determine a second part quality of the part in the same digital image, the AI inspection module generating a second part quality output based on the analysis of the same digital image, wherein the part inspection module compares the first part quality output and the second part quality output.

2. The part inspection system of claim 1, wherein the AI inspection module is trained with the digital image of the part.

3. The part inspection system of claim 1, wherein the AI inspection module verifies the part quality when the first and second part quality outputs are the same.

4. The part inspection system of claim 1, wherein the part inspection module performs additional part inspection if the first and second part quality outputs are different.

5. The part inspection system of claim 1, wherein the first part quality output is one of PASS or FAIL and the second part quality output is one of PASS or FAIL, wherein the part inspection by the part inspection module is completed if both the first and second part quality outputs are PASS or if both the first and second part quality outputs are FAIL, and wherein the part inspection module performs additional part inspection if one of the first and second part quality outputs is PASS and the other of the first and second part quality outputs is FAIL.

6. The part inspection system of claim 1, wherein the part inspection module includes a review module, the digital image being sent to the review module if the first part quality output is different than the second part quality output, the digital image being further analyzed by the review module to determine if the first part quality output or the second part quality output is correct.

7. The part inspection system of claim 6, wherein the digital image in the review module is reviewed by a human operator to determine if the first part quality output or the second part quality output is correct.

8. The part inspection system of claim 6, wherein the digital image is used to train the AI inspection module after review by the review module.

9. The part inspection system of claim 6, wherein the review module sends a prompt to an operator of the part inspection module based on an output from the review module.

10. A part inspection system comprising:
a vision device configured to image a part being inspected and generate a digital image of the part;
a part inspection module for inspecting part quality of the part based on the digital image of the part, the part inspection module including a machine vision inspection module and an AI inspection module, the machine vision inspection module receiving the digital image of the part, the machine vision inspection module analyzing the digital image to determine a first part quality of the part in the digital image, the machine vision inspection module generating a first part quality output based on the analysis of the digital image, the first part quality output being one of PASS or FAIL, the AI inspection module receiving the same digital image of the part, the AI inspection module analyzing the digital image to determine a second part quality of the part in the same digital image, the AI inspection module generating a second part quality output based on the analysis of the same digital image, the second part quality output being one of PASS or FAIL, wherein the part inspection module compares the first part quality output and the second part quality output to determine if the first and second part quality outputs are the same or different, wherein the part inspection module performs additional part inspection if the first and second part quality outputs are different.

11. The part inspection system of claim 10, wherein the AI inspection module is trained with the digital image of the part.

12. The part inspection system of claim 10, wherein the AI inspection module verifies the part quality when the first and second part quality outputs are the same.

13. The part inspection system of claim 10, wherein the part inspection by the part inspection module is completed if both the first and second part quality outputs are PASS or if both the first and second part quality outputs are FAIL, and wherein the part inspection module performs additional part inspection if one of the first and second part quality outputs is PASS and the other of the first and second part quality outputs is FAIL.

14. The part inspection system of claim 10, wherein the part inspection module includes a review module, the digital image being sent to the review module if the first part quality output is different than the second part quality output, the digital image being further analyzed by the review module to determine if the first part quality output or the second part quality output is correct.

15. The part inspection system of claim 14, wherein the digital image in the review module is reviewed by a human operator to determine if the first part quality output or the second part quality output is correct.

16. The part inspection system of claim 14, wherein the digital image is used to train the AI inspection module after review by the review module.

17. The part inspection system of claim 14, wherein the review module sends a prompt to an operator of the part inspection module based on an output from the review module.

18. A part inspection method comprising:
imaging a part using a vision device to generate a digital image;
analyzing the digital image through a machine vision inspection module of a part inspection system by comparing the digital image to a quality threshold to determine if the digital image passes or fails the quality threshold, the machine vision inspection module generating a first part quality output;
analyzing the digital image through an AI inspection module of the part inspection system by comparing the digital image to a quality threshold to determine if the digital image passes or fails the quality threshold, the AI inspection module generating a second part quality output; and
comparing the first part quality output and the second part quality output to determine if the first and second part quality outputs are the same or different, wherein the part inspection system performs additional part inspection if the first and second part quality outputs are different.

19. The part inspection method of claim 18, wherein the first part quality output is one of PASS or FAIL and the second part quality output is one of PASS or FAIL, said comparing the first part quality output and the second part quality output comprises completing inspection if both the first and second part quality outputs are PASS or if both the first and second part quality outputs are FAIL, and said comparing the first part quality output and the second part quality output comprises performing additional part inspection if one of the first and second part quality outputs is PASS and the other of the first and second part quality outputs is FAIL.

20. The part inspection method of claim 18, further comprising sending the digital image to an operator for review if the first and second part quality outputs are different.
